(19) United States
(12) Patent Application Publication
(10) Pub. No.: US 2011/0158546 A1
(43) Pub. Date: Jun. 30, 2011

(54) SYSTEM AND METHOD FOR GENERATING CONTROL INSTRUCTION BY USING IMAGE PICKUP DEVICE TO RECOGNIZE USERS POSTURE

(75) Inventors: Ying-Jieh Huang, Taipei (TW); Xu-Hua Liu, Beijing (CN); Fei Tan, Beijing (CN)

(73) Assignee: Primax Electronics Ltd., Taipei (TW)

(21) Appl. No.: 12/723,417

(22) Filed: Mar. 12, 2010

(30) Foreign Application Priority Data
Dec. 25, 2009 (TW) 098144961

(51) Int. Cl. G06K 9/62

(52) U.S. Cl. 382/224

(57) ABSTRACT

A system and a method are provided for generating a control instruction by using an image pickup device to recognize a user's posture. An electronic device is controlled according to different composite postures. Each composite posture is a combination of the hand posture, the head posture and the facial expression change of the user. Each composite posture indicates a corresponding control instruction. Since the composite posture is more complex than peoples' habitual actions, the possibility of causing erroneous control instruction from unintentional habitual actions of the user will be minimized or eliminated.

### FIELD OF THE INVENTION

The present invention relates to an automatic control system and an automatic control method, and more particularly to a system and a method for generating a control instruction by using an image pickup device to recognize a user's posture.

### BACKGROUND OF THE INVENTION

With increasing development of digitalized technologies, a variety of electronic devices are designed in views of convenience and user-friendliness. For helping the user well operate the electronic devices, the electronic devices are gradually developed in views of humanization. For example, the use of a remote controller may facilitate the user to manipulate an electronic device such as a television. By using the remote controller, the user could remotely change channel to view a desired TV program or adjust the sound volume of the television. Although the use of the remote controller to control the television is convenient, there are still some drawbacks. For example, if the remote controller is not available, the user needs to operate the control buttons of the television to control the television. In addition, in a case that the control buttons are not included in the television, the user fails to control the television without the remote controller.

Moreover, a mouse or a keyboard is a common input device for inputting a control instruction to control application programs of a computer. When the computer is continuously used for a long term, the muscles at the neck, shoulders or hands of the user are usually fatigable, which is detrimental to the health. Moreover, since the mouse and the keyboard are physical devices, the use of the mouse or keyboard occupies much operating space.

For solving the above drawbacks, a method for inputting a control instruction to an electronic device by using an image processing technology is disclosed. A video camera is installed on the electronic device. Hereinafter, a process for executing a specified control instruction will be illustrated. First of all, the user may pose his (her) body to have a specified posture (e.g. a sitting posture) or a specified action, which has been previously defined. Then, the image of the specified posture or action is capture by the video camera, which is in communication with the electronic device. The image of the specified posture or action is analyzed and recognized by the electronic device. The recognized image is then compared with the instruction images stored in the database of the electronic device, so that a complied control instruction is searched by the electronic device. For example, according to settings, the video playback program is opened in the computer when both hands of the user are raised, or the television is turned off when the mouth of the user is opened as an O-shaped mouth. It is found that the habitual action of the user may cause the electronic device to erroneously discriminate the control instruction. For example, in a case that the body is fatigued, the user may naturally stretch himself (or herself). The self-stretching action is readily confused with the action of raising hands. In addition, in a case that the user is sleepy, the user may naturally yawn. The yawning action is readily confused with the action opening the mouth as O-shaped mouth.

Recently, a method is provided for preventing from erroneously discriminating the control instruction and confirming the control instruction. For executing a control instruction, the user firstly poses a specified posture or action to indicate beginning of the execution of the control instruction. Then, the user poses another posture or action corresponding to the control instruction. Afterwards, the user poses the specified posture or action again to indicate the completion of the posture or action corresponding to the control instruction and confirm the control instruction. For example, the user may firstly pose a right hand grip posture to indicate that the computer begins to execute a control instruction; then, the both hands of the user are raised to open a video playback program in the computer; and finally the user may pose the right hand grip posture again to indicate the control instruction to be executed is inputted and confirm the control instruction. In other words, a series of postures or actions are performed to input and confirm the control instruction. This method, however, increases the time of inputting the control instruction and fails to meet the requirements of humanization.

Recently, a sound control technology is provided for preventing the electronic device from erroneously discriminating the control instruction. For executing a control instruction, the user may firstly pose a posture or action corresponding to the control instruction while producing a sound “start” or “end” to input and confirm the control instruction. This method, however, still has some drawbacks. Since most people prefer a quiet environment, too loud sound incurs noise pollution to the environment. Moreover, the sound control technology is not feasible to the deaf and dumb people.

### SUMMARY OF THE INVENTION

The present invention relates to a system and a method for generating a control instruction by using an image pickup device to recognize a user's posture, and more particularly to a system and a method for generating a control instruction by recognizing a composite posture including a hand posture and a head posture of a user.

In accordance with an aspect of the present invention, there is provided a system for generating a control instruction by using an image pickup device to recognize a user's posture. The system is in communication with an electronic device. The electronic device is controlled by the system according to a composite posture including a hand posture and a head posture of a user. The system includes an image pickup unit, an image analyzing unit, a database unit, a comparing unit and an instruction processing unit. The image pickup unit is used for capturing an image of the composite posture. The image analyzing unit is in communication with the image pickup unit for recognizing the image of the composite posture. The database unit is used for storing plural reference image data and control instructions corresponding to the plural reference image data. The comparing unit is in communication with the image analyzing unit and the database unit for comparing the image of the composite posture with the plural reference image data stored in the database unit, thereby searching a specified reference image data complied with the image of the composite posture and acquiring a specified control instruction corresponding to the specified reference image data. The instruction processing unit is in communication with the comparing unit and the electronic device for transmitting the specified control instruction searched by the comparing unit to the electronic device.

In an embodiment, the head posture includes a facial expression or a facial expression change.

In an embodiment, the facial expression change includes a left eye opening/closing motion of the user, a right eye opening/closing motion of the user, a mouth opening/closing motion of the user or a combination of any two thereof.

In an embodiment, the image analyzing unit includes a hand image analyzing subunit, a head image analyzing subunit, a facial image analyzing subunit and a composite posture image analyzing subunit. The hand image analyzing subunit is used for detecting a hand's position of the user in the image of the composite posture, thereby analyzing the hand posture of the user. The head image analyzing subunit is used for detecting a head's position of the user in the image of the composite posture, thereby analyzing the head posture of the user. The facial image analyzing subunit is used for detecting relative positions of facial features in the image of the composite posture, thereby analyzing the facial expression or the facial expression change of the user. The composite posture image analyzing subunit is used for recognizing the image of the composite posture according an overall analyzing result obtained by the hand image analyzing subunit, the head image analyzing subunit and the facial image analyzing subunit.

In an embodiment, the static head posture includes a head frontward posture of the user, a head rightward posture of the user, a head leftward posture of the user, a head upward posture of the user, a head leftward-tilt posture of the user or a head rightward-tilt posture of the user.

In an embodiment, the dynamic head posture includes a nodding motion of the user, a head-shaking motion of the user, a head clockwise circling motion of the user or a head anti-clockwise circling motion of the user.

In an embodiment, the hand posture includes a static hand gesture or a dynamic hand gesture.

In an embodiment, the static hand gesture includes a static hand posture, a static arm posture, or a combination of the static hand posture and the static arm posture.

In an embodiment, the static hand posture includes a static left hand posture of the user, a static right hand posture of the user, or a combination of the static left hand posture and the static right hand posture.

In an embodiment, the static left hand posture includes a left palm open posture, a left hand grip posture, a left-hand single-finger extension posture, a left-hand two-finger extension posture, a left-hand three-finger extension posture or a left-hand four-finger extension posture.

In an embodiment, the static right hand posture includes a right palm open posture, a right hand grip posture, a right-hand single-finger extension posture, a right-hand two-finger extension posture, a right-hand three-finger extension posture or a right-hand four-finger extension posture.

In an embodiment, the static arm posture includes a static left arm posture, a static right arm posture, or a combination of the static left arm posture and the static right arm posture.

In an embodiment, the static left arm posture is a posture of placing a left arm in a specified direction.

In an embodiment, the static right arm posture is a posture of placing a right arm in a specified direction.

In an embodiment, the dynamic hand gesture is obtained by once moving the static hand gesture in a single motion or repeatedly moving the static hand gesture in a repeated motion.

In an embodiment, the single motion includes a clockwise circling motion, an anti-clockwise circling motion, a clicking motion, a crossing motion, a ticking motion, a triangle-drawing motion, an upward sweeping motion, a leftward sweeping motion, a rightward sweeping motion or a combination of any two thereof.

In an embodiment, the repeated motion includes a repeated clockwise circling motion, a repeated anti-clockwise circling motion, a repeated clicking motion, a repeated crossing motion, a repeated ticking motion, a repeated triangle-drawing motion, a repeated upward sweeping motion, a repeated leftward sweeping motion, a repeated rightward sweeping motion or a combination of any two thereof.

In accordance with another aspect of the present invention, there is provided a method for generating a control instruction to control an electronic device by using an image pickup device to recognize a user's posture. Firstly, an image of a composite posture of a user is captured. The composite posture includes a hand posture of the user and a head posture of the user. Then, the image of the composite posture is recognized. Then, the recognized image of the composite posture is compared with predetermined reference image data, thereby acquiring a control instruction corresponding to the predetermined reference image data. Afterwards, the control instruction is inputted into the electronic device.

In an embodiment, the hand posture includes a static hand gesture or a dynamic hand gesture, and the head posture includes a static head posture and a dynamic head posture.

In an embodiment, the method further includes a step of acquiring the static head posture of the user according to a position of a face feature point of the user in the image, or discriminating the dynamic head posture of the user according to a change of the static head posture of the user in a series of continuous images.

In an embodiment, the face feature point of the user includes two ends of an eyebrow, a pupil, a corner of an eye, a nose, a corner of a moth, or a combination of any two thereof.

In an embodiment, the method further includes a step of acquiring the static hand gesture of the user according to a position of a hand feature point of the user in the image, and/or discriminating the dynamic hand gesture of the user according to a change of the static hand gesture of the user in a series of continuous images.

In an embodiment, the hand feature point of the user includes a palm, a finger, an arm, or a combination of any two thereof.

In an embodiment, the head posture includes a facial expression or a facial expression change.

In an embodiment, the method further includes a step of acquiring the facial expression of the user according to relative positions of facial features of the user in the image, or discriminating the facial expression change of the user according to a relative position change of the facial features of the user in a series of continuous images.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a system for generating a control instruction by using an image pickup device to recognize a user's posture according to an embodiment of the present invention;

FIG. 2 is a flowchart illustrating a method for generating a control instruction by using an image pickup device to recognize a user's posture according to an embodiment of the present invention;

FIG. 3A schematically illustrates several exemplary static right hand postures according to the present invention;

FIG. 3B schematically illustrates several exemplary static left hand postures according to the present invention;

FIG. 4A schematically illustrates several exemplary static left arm postures according to the present invention;

FIG. 4B schematically illustrates several exemplary static right arm postures according to the present invention;

FIG. 5 schematically illustrates several exemplary dynamic hand gestures according to the present invention;

FIG. 6 schematically illustrates several exemplary static head postures according to the present invention;

FIG. 7 schematically illustrates several exemplary dynamic head postures according to the present invention; and

FIG. 8 schematically illustrates several exemplary facial expression changes according to the present invention.

### DETAILED DESCRIPTION OF THE PREFERRED EMBODIMENT

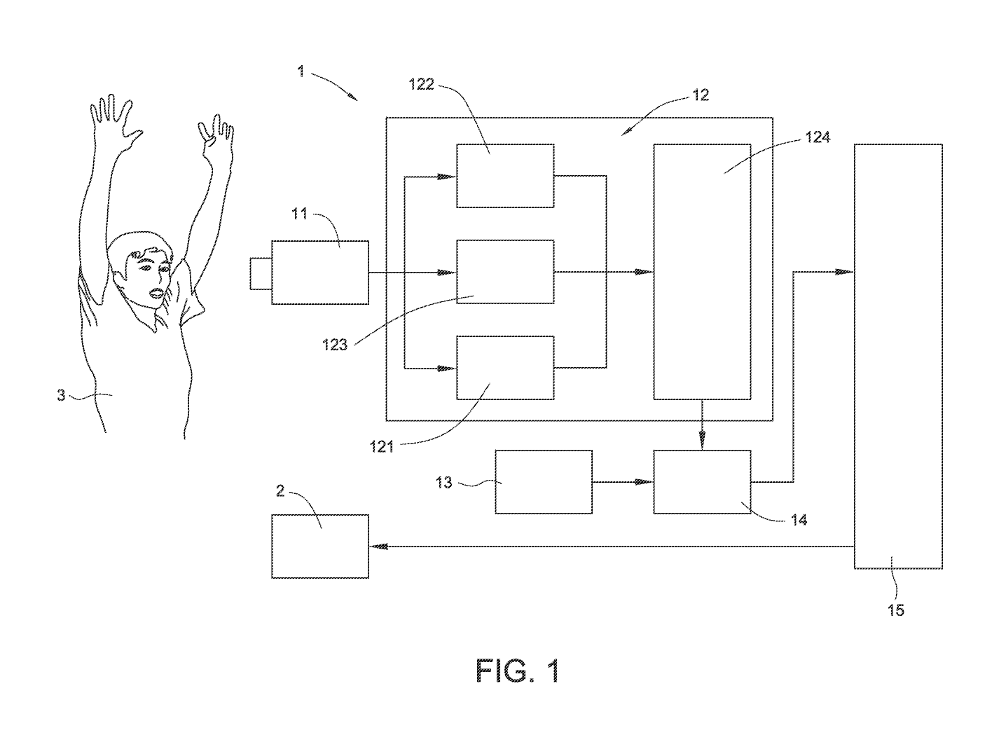

FIG. 1 is a schematic functional block diagram illustrating a system for generating a control instruction by using an image pickup device to recognize a user's posture according to an embodiment of the present invention. The system 1 is in communication with an electronic device 2. By sensing a composite posture including a hand posture and a head posture of a user 3, the system 1 can control the electronic device 2. An example of the electronic device 2 includes but is not limited to a computer, a television or any other remotely-controllable electronic equipment. The head posture of the composite posture includes a facial expression or a facial expression change of the user 3. In other words, the composite posture is a combined result of the hand posture, the head posture and the facial expression or the facial expression change.

As shown in FIG. 1, the system 1 comprises an image pickup unit 11, an image analyzing unit 12, a database unit 13, a comparing unit 14 and an instruction processing unit 15. The image pickup unit 11 is used for capturing the image of the composite posture. The image analyzing unit 12 is in communication with the image pickup unit 11 for recognizing the image of the composite posture that is captured by the image pickup unit 11. In this embodiment, the image analyzing unit 12 comprises a hand image analyzing subunit 121, a head image analyzing subunit 122, a facial image analyzing subunit 123 and a composite posture image analyzing subunit 124. The hand image analyzing subunit 121 is used for detecting the hand's position in the image, thereby analyzing the hand posture. The head image analyzing subunit 122 is used for detecting the head's position in the image, thereby analyzing the head posture. The facial image analyzing subunit 123 is used for detecting relative positions of the facial features in the image, thereby analyzing a facial expression or a facial expression change of the user 3. According to the overall analyzing result obtained by the hand image analyzing subunit 121, the head image analyzing subunit 122 and the facial image analyzing subunit 123, the image of the composite posture is recognized by the composite posture image analyzing subunit 124. In this embodiment, the hand posture includes a static hand gesture or a dynamic hand gesture, and the head posture includes a static head posture or a dynamic head posture, which will be illustrated later.

The database unit 13 stores plural reference image data and the control instructions corresponding to the plural reference image data. The comparing unit 14 is in communication with the image analyzing unit 12 and the database unit 13. By the comparing unit 14, the image of the composite posture recognized by the image analyzing unit 12 is compared with the plural reference image data stored in the database unit 13, so that the reference image data complied with the image of the composite posture is searched. According to the reference image data complied with the image of the composite posture, a control instruction corresponding to the composite posture of the user 3 is acquired by the system 1. The instruction processing unit 15 of the system 1 is disposed between the comparing unit 14 and the electronic device 2, and in communication with the comparing unit 14 and the electronic device 2. The control instruction acquired by the system 1 is inputted into the electronic device 2 through the instruction processing unit 15. The electronic device 2 is operated according to the control instruction.

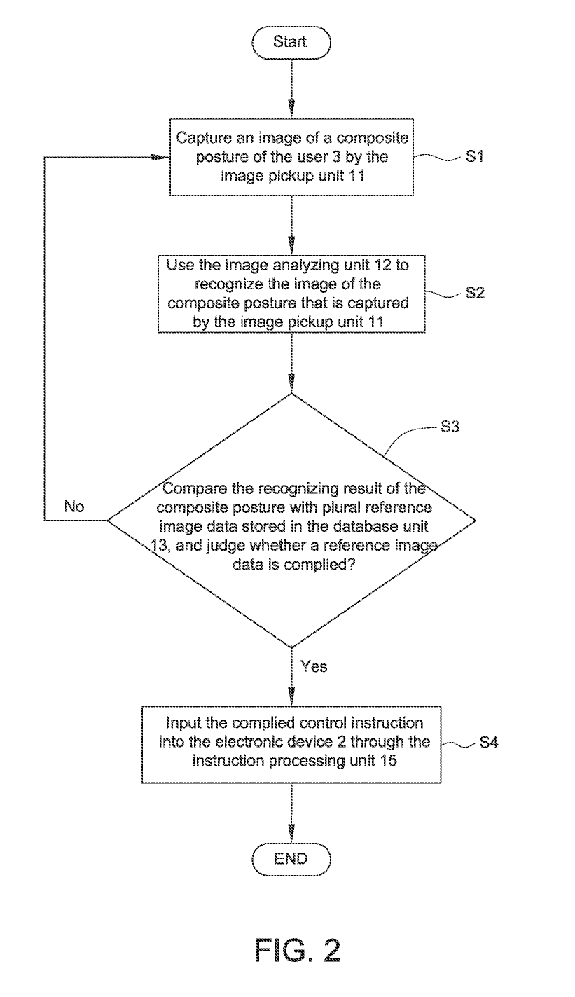

FIG. 2 is a flowchart illustrating a method for generating a control instruction by using an image pickup device to recognize a user's posture according to an embodiment of the present invention.

In Step S1, an image of a composite posture of the user 3 is captured by the image pickup unit 11.

In Step S2, the image of the composite posture that is captured by the image pickup unit 11 is recognized by the image analyzing unit 12. According to the position of a face feature point of the user 3 in the image, the head image analyzing subunit 122 of the image analyzing unit 12 can acquire a static head posture of the user 3. Alternatively, according to the change of the static head posture of the user 3 in a series of continuous images, the head image analyzing subunit 122 can discriminate a dynamic head posture of the user 3. The dynamic head posture indicates the moving direction of the head. The face feature point of the user 3 includes two ends of an eyebrow, a pupil, a corner of an eye, a nose, a corner of a moth, or a combination of any two of these face feature points. Similarly, according to the position of a hand feature point of the user 3 in the image, the hand image analyzing subunit 121 of the image analyzing unit 12 can acquire a static hand gesture of the user 3. Alternatively, according to the change of the static hand gesture of the user 3 in a series of continuous images, the hand image analyzing subunit 121 can discriminate a dynamic hand gesture of the user 3. The dynamic hand gesture indicates the moving direction of the hand. The hand feature point of the user 3 includes a palm, a finger, an arm, or a combination of any two of these hand feature points. Then, according to the relative positions of the facial features of the user 3 in the image, the image analyzing subunit 123 acquires the facial expression of the user 3. Alternatively, according to the relative position change of the facial features of the user 3 in a series of continuous images, the image analyzing subunit 123 acquires can discriminate the facial expression change of the user 3. According to the overall analyzing result obtained by the hand image analyzing subunit 121, the head image analyzing subunit 122 and the facial image analyzing subunit 123, a recognizing result of the composite posture is outputted by the composite posture image analyzing subunit 124.

In Step S3, the recognizing result of the composite posture is compared with plural reference image data stored in the database unit 13, and a reference image data complied with the image of the composite posture is searched. According to the reference image data complied with the image of the composite posture, a corresponding control instruction is issued from the comparing unit 14 to the instruction processing unit 15. On the other hand, if no reference image data is complied, Steps S1, S2 and S3 are repeatedly done.

In Step S4, the complied control instruction is inputted into the electronic device 2 through the instruction processing unit 15.

Some examples of the hand postures will be illustrated as follows. The hand posture includes a static hand gesture or a dynamic hand gesture. The static hand gesture includes a static hand posture, a static arm posture, or a combination of the static hand posture and the static arm posture. The static hand posture includes a static left hand posture, a static right hand posture, or a combination of the static left hand posture and the static right hand posture. The static arm posture includes a static left arm posture, a static right arm posture, or a combination of the static left arm posture and the static right arm posture.

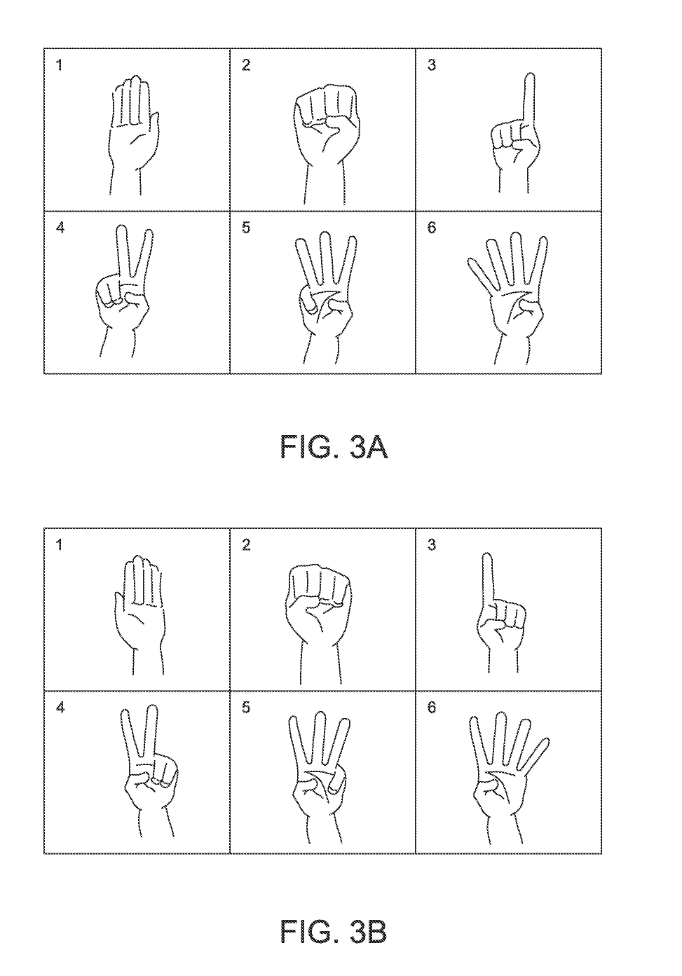

FIG. 3A schematically illustrates several exemplary static right hand postures according to the present invention. For example, the static right hand posture includes a right palm open posture (block 1), a right hand grip posture (block 2), a right-hand single-finger extension posture (block 3), a right-hand two-finger extension posture (block 4), a right-hand three-finger extension posture (block 5) or a right-hand four-finger extension posture (block 6). FIG. 3B schematically illustrates several exemplary static left hand postures according to the present invention. For example, the static left hand posture includes a left palm open posture (block 1), a left hand grip posture (block 2), a left-hand single-finger extension posture (block 3), a left-hand two-finger extension posture (block 4), a left-hand three-finger extension posture (block 5) or a left-hand four-finger extension posture (block 6).

The hand postures shown in FIGS. 3A and 3B are presented herein for purpose of illustration and description only. It is noted that numerous modifications and alterations may be made while retaining the teachings of the invention. For example, the right-hand single-finger extension posture in the block 3 of FIG. 3A and the left-hand single-finger extension posture in the block 3 of FIG. 3B are not restricted to the extension posture of the forefinger. For example, the forefinger may be replaced by a middle finger. Moreover, the extension posture is not restricted to a specified extension direction. That is, the extension posture is not restricted to the upward extension direction as shown in FIG. 3. Nevertheless, the finger or fingers may be extended in any arbitrary extension direction.

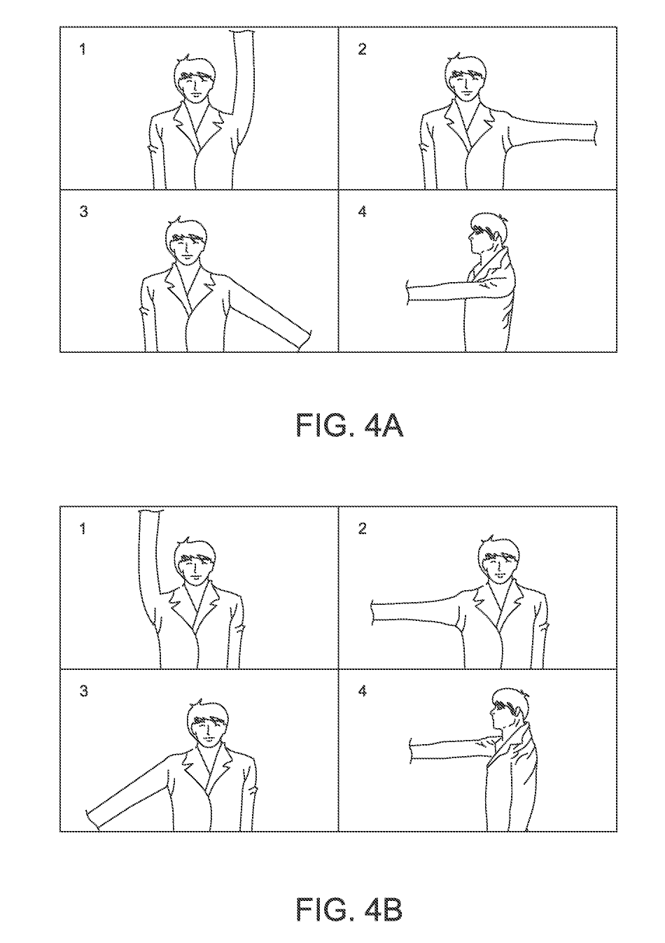

The static left arm posture is a posture of placing the left arm in a specified direction. FIG. 4A schematically illustrates several exemplary static left arm postures according to the present invention. For example, the static left arm posture includes a left arm upward-placement posture (block 1), a left arm leftward-placement posture (block 2), a left arm downward-placement posture (block 3) or a left arm frontward-placement posture (block 4). FIG. 4B schematically illustrates several exemplary static right arm postures according to the present invention. For example, the static right arm posture includes a right arm upward-placement posture (block 1), a right arm rightward-placement posture (block 2), a right arm downward-placement posture (block 3) or a right arm frontward-placement posture (block 4).

In other words, the static hand gesture is a combined result of any static left hand posture, any static right hand posture, any static left arm posture and any static right arm posture described above. By once moving the static left hand posture, the static right hand posture, the static left arm posture or the static right arm posture, a dynamic hand gesture with a single motion is obtained. Alternatively, by repeatedly moving the static left hand posture, the static right hand posture, the static left arm posture or the static right arm posture, a dynamic hand gesture with a repeated reciprocating motion is obtained.

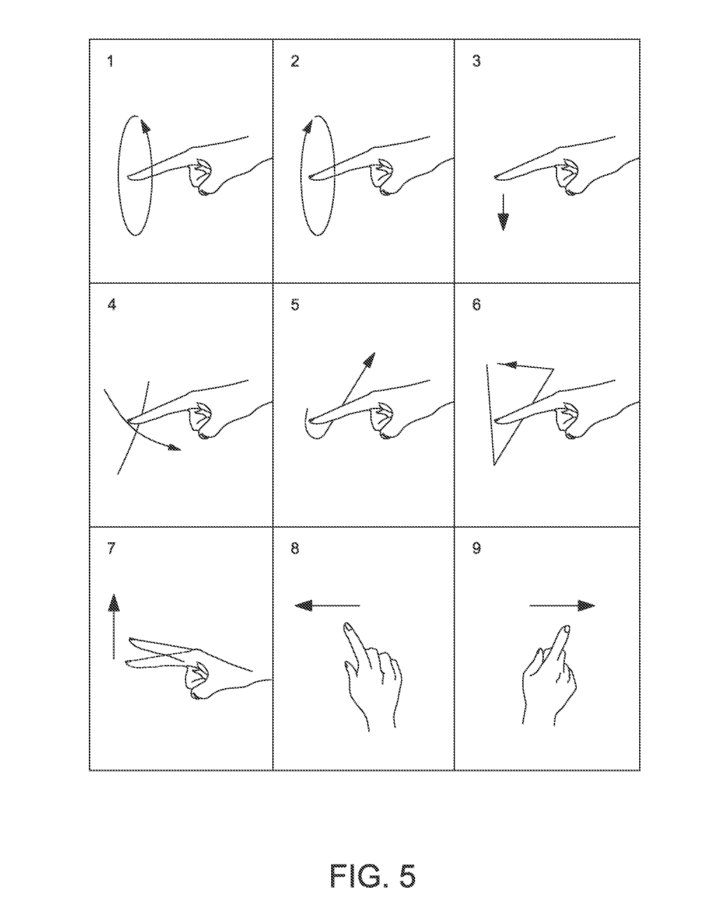

FIG. 5 schematically illustrates several exemplary dynamic hand gestures according to the present invention. These exemplary dynamic hand gestures are illustrated by referring to a forefinger of a right hand. For example, the dynamic hand gesture includes a clockwise circling motion (block 1), an anti-clockwise circling motion (block 2), a clicking motion (block 3), a crossing motion (block 4), a ticking motion (block 5), a triangle-drawing motion (block 6), an upward sweeping motion (block 7), a leftward sweeping motion (block 8), a rightward sweeping motion (block 9) or a combination of any two of these motions. The dynamic hand gestures are not restricted to the gestures of the forefinger of the right hand. In other words, the dynamic hand gesture is a combined result of the motion of any static left hand posture, the motion of any static right hand posture, the motion of any static left arm posture and the motion of any static right arm posture. For example, the combination of a repeated upward sweeping motion of a left hand of the user 3 and a single anti-clockwise circling motion of the right hand grip posture is also a dynamic hand gesture.

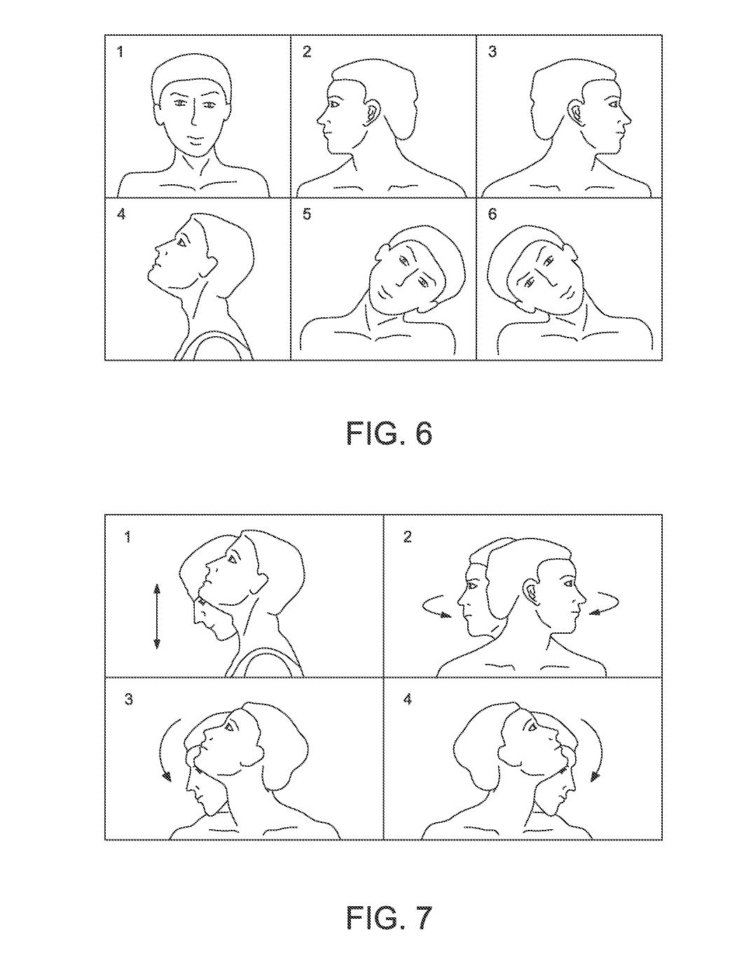

The head posture will be illustrated as follows. As previously described, the head posture includes a static head posture or a dynamic head posture. FIG. 6 schematically illustrates several exemplary static head postures according to the present invention. The static head posture includes a head frontward posture of the user 3 (block 1), a head rightward posture of the user 3 (block 2), a head leftward posture of the user 3 (block 3), a head upward posture of the user 3 (block 4), a head leftward-tilt posture of the user 3 (block 5) or a head rightward-tilt posture of the user 3 (block 6).

FIG. 7 schematically illustrates several exemplary dynamic head postures according to the present invention. The dynamic head posture includes a nodding motion of the user 3 (block 1), a head-shaking motion of the user 3 (block 2), a head clockwise circling motion of the user 3 (block 3) or a head anti-clockwise circling motion of the user (block 4).

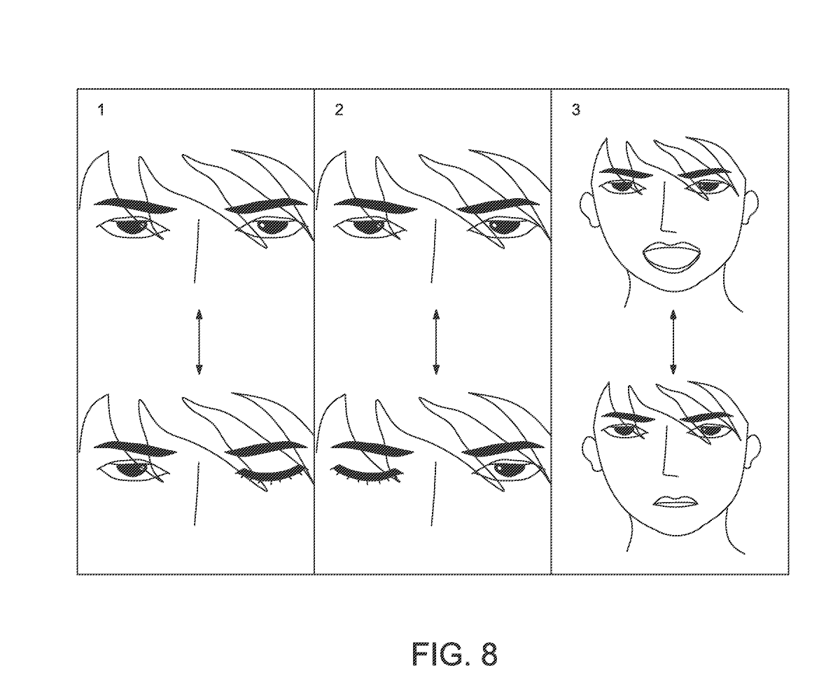

The facial expression or the facial expression change will be illustrated as follows. FIG. 8 schematically illustrates several exemplary facial expression changes according to the present invention. The facial expression change includes a left eye opening/closing motion of the user 3 (block 1), a right eye opening/closing motion of the user 3 (block 2), a mouth opening/closing motion of the user 3 (block 4) or a combination of any two of theses motions.

From the above description, the composite posture is a combined result of any hand posture and any head posture or any facial expression change described above. Each composite posture indicates a corresponding control instruction. Since the composite posture is more complex than peoples' habitual actions, the possibility of erroneously inputting the control instruction into the electronic device 2 by the unintentional habitual actions of the user 3 will be minimized or eliminated. In other words, when a control instruction corresponding to a specified composite posture of the user 3 is transmitted to the electronic device 2, the control instruction is simultaneously confirmed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A system for generating a control instruction by using an image pickup device to recognize a user's posture, said system being in communication with an electronic device, said electronic device being controlled by said system according to a composite posture including a hand posture and a head posture of a user, said system comprising:
an image pickup unit for capturing an image of said composite posture;
an image analyzing unit in communication with said image pickup unit for recognizing said image of said composite posture;
a database unit for storing plural reference image data and control instructions corresponding to said plural reference image data;
a comparing unit in communication with said image analyzing unit and said database unit for comparing said image of said composite posture with said plural reference image data stored in said database unit, thereby searching a specified reference image data complied with said image of said composite posture and acquiring a specified control instruction corresponding to said specified reference image data; and
an instruction processing unit in communication with said comparing unit and said electronic device for transmitting said specified control instruction searched by said comparing unit to said electronic device.

2. The system according to claim 1 wherein said head posture includes a facial expression or a facial expression change.

3. The system according to claim 2 wherein said facial expression change includes a left eye opening/closing motion of said user, a right eye opening/closing motion of said user, a mouth opening/closing motion of said user or a combination of any two thereof.

4. The system according to claim 2 wherein said image analyzing unit comprises:
a hand image analyzing subunit for detecting a hand's position of said user in said image of said composite posture, thereby analyzing said hand posture of said user;
a head image analyzing subunit for detecting a head's position of said user in said image of said composite posture, thereby analyzing said head posture of said user;
a facial image analyzing subunit for detecting relative positions of facial features in said image of said composite posture, thereby analyzing said facial expression or said facial expression change of said user; and
a composite posture image analyzing subunit for recognizing said image of said composite posture according an overall analyzing result obtained by said hand image analyzing subunit, said head image analyzing subunit and said facial image analyzing subunit.

5. The system according to claim 1 wherein said head posture includes a static head posture and a dynamic head posture.

6. The system according to claim 5 wherein said static head posture includes a head frontward posture of said user, a head rightward posture of said user, a head leftward posture of said user, a head upward posture of said user, a head leftward-tilt posture of said user or a head rightward-tilt posture of said user.

7. The system according to claim 5 wherein said dynamic head posture includes a nodding motion of said user, a head-shaking motion of said user, a head clockwise circling motion of said user or a head anti-clockwise circling motion of said user.

8. The system according to claim 1 wherein said hand posture includes a static hand gesture or a dynamic hand gesture.

9. The system according to claim 8 wherein said static hand gesture includes a static hand posture, a static arm posture, or a combination of said static hand posture and said static arm posture.

10. The system according to claim 9 wherein said static hand posture includes a static left hand posture of said user, a static right hand posture of said user, or a combination of said static left hand posture and said static right hand posture.

11. The system according to claim 10 wherein said static left hand posture includes a left palm open posture, a left hand grip posture, a left -hand single-finger extension posture, a left-hand two-finger extension posture, a left-hand three-finger extension posture or a left-hand four-finger extension posture.

12. The system according to claim 10 wherein said static right hand posture includes a right palm open posture, a right hand grip posture, a right-hand single-finger extension posture, a right-hand two-finger extension posture, a right-hand three-finger extension posture or a right-hand four-finger extension posture.

13. The system according to claim 9 wherein said static arm posture includes a static left arm posture, a static right arm posture, or a combination of said static left arm posture and said static right arm posture.

14. The system according to claim 13 wherein said static left arm posture is a posture of placing a left arm in a specified direction.

15. The system according to claim 13 wherein said static right arm posture is a posture of placing a right arm in a specified direction.

16. The system according to claim 9 wherein said dynamic hand gesture is obtained by once moving said static hand gesture in a single motion or repeatedly moving said static hand gesture in a repeated motion.

17. The system according to claim 16 wherein said single motion includes a clockwise circling motion, an anti-clockwise circling motion, a clicking motion, a crossing motion, a ticking motion, a triangle-drawing motion, an upward sweeping motion, a leftward sweeping motion, a rightward sweeping motion or a combination of any two thereof.

18. The system according to claim 16 wherein said repeated motion includes a repeated clockwise circling motion, a repeated anti-clockwise circling motion, a repeated clicking motion, a repeated crossing motion, a repeated ticking motion, a repeated triangle-drawing motion, a repeated upward sweeping motion, a repeated leftward sweeping motion, a repeated rightward sweeping motion or a combination of any two thereof.

19. A method for generating a control instruction to control an electronic device by using an image pickup device to recognize a user's posture, said method comprising steps of:
capturing an image of a composite posture of a user, wherein said composite posture comprises a hand posture of said user and a head posture of said user;
recognizing said image of said composite posture;
comparing said recognized image of said composite posture with predetermined reference image data, thereby acquiring a control instruction corresponding to said predetermined reference image data; and
inputting said control instruction into said electronic device.

20. The method according to claim 19 wherein said hand posture includes a static hand gesture or a dynamic hand gesture, and said head posture includes a static head posture and a dynamic head posture.

21. The method according to claim 20 further comprising a step of acquiring said static head posture of said user according to a position of a face feature point of said user in said image, or discriminating said dynamic head posture of said user according to a change of said static head posture of said user in a series of continuous images.

22. The method according to claim 21 wherein said face feature point of said user includes two ends of an eyebrow, a pupil, a corner of an eye, a nose, a corner of a moth, or a combination of any two thereof.

23. The method according to claim 20 further comprising a step of acquiring said static hand gesture of said user according to a position of a hand feature point of said user in said image, and/or discriminating said dynamic hand gesture of said user according to a change of said static hand gesture of said user in a series of continuous images.

24. The method according to claim 23 wherein said hand feature point of said user includes a palm, a finger, an arm, or a combination of any two thereof.

25. The method according to claim 19 wherein said head posture includes a facial expression or a facial expression change.

26. The method according to claim 25 further comprising a step of acquiring said facial expression of said user according to relative positions of facial features of said user in said image, or discriminating said facial expression change of said user according to a relative position change of said facial features of said user in a series of continuous images.
